(19) United States
(12) Patent Application Publication
(10) Pub. No.: US 2012/0072492 A1
(43) Pub. Date: Mar. 22, 2012

(54) BROWSING INFORMATION GATHERING SYSTEM, BROWSING INFORMATION GATHERING METHOD, SERVER, AND RECORDING MEDIUM

(75) Inventors: Satoshi Aoki, Minato-ku (JP); Takayuki Ishikawa, Minato-ku (JP); Masaru Kawakita, Minato-ku (JP); Shuntaro Nagai, Minato-ku (JP); Shigeyoshi Shima, Minato-ku (JP)

(73) Assignee: NEC CORPORATION, Minato-ku, Tokyo (JP)

(21) Appl. No.: 13/321,642

(22) PCT Filed: May 27, 2010
(86) PCT No.: PCT/JP2010/059014

§ 371 Date: Nov. 21, 2011

(30) Foreign Application Priority Data
May 28, 2009 (JP) 2009-129083

(51) Int. Cl. G06F 15/16

(52) U.S. Cl. 709/203

(57) ABSTRACT

When a client transmits an HTML request to a server (step S5), the server generates HTML texts (step S7), and transmits the generated texts to the client (step S8). A control unit obtains information displayed by a browser (step S11), and determines whether or not confidential information like personal information is displayed by the browser and it is necessary to create a log, and creates the log if necessary (step S12). When creating the log, the control unit transmits the created log to the WWW server (step S13).

### TECHNICAL FIELD

The present invention relates to a browsing information gathering system, a browsing information gathering method, a server and a recording medium.

### BACKGROUND ART

Recently, personal information and confidential information are managed by a computer. When leaking of such information and a security incident occur, it is necessary to promptly identify a fraudulent person.

A trail data extracting method is proposed which collects a log of browsed pages by a user when the user logs in (see, for example, patent literature 1).

### PRIOR ART DOCUMENT

Patent Literature
Patent Literature 1: Unexamined Japanese Patent Application KOKAI Publication No. 2008-299126

### DISCLOSURE OF INVENTION

### Problem to be Solved by the Invention

However, there are cases in which accessed information are not consistent with information displayed by a browser like a case in which confidential information is included outside the display range of the browser, and there is a possibility that it is difficult to specify information actually browsed by a user.

Moreover, it is possible to take a log as image data which is information browsed by a user, but in this case, the volume of the log becomes heavy, and it is difficult to search information browsed by the user on the basis of a keyword.

The present invention is made in view of the above-explained technical issue, and it is an object of the present invention to provide a browsing information gathering system, a browsing information gathering method, a server and a recording medium which are capable of preferably collecting information browsed by a user.

### Means for Solving the Problem

In order to achieve the above object, a browsing information gathering system according to a first aspect of the present invention includes a client and a server that stores data, the client and the server are connected together, the client includes a document request unit that requests the data to the server, the server includes a data transmitting unit that adds identification information to the data requested by the client and that transmits the data with the identification information to the client, the client further includes: a browsing unit that browses the data transmitted from the server; a determining unit that determines whether or not specific information is browsed through the browsing unit based on the identification information added to the data; and a browsing information transmitting unit that transmits browsing information indicating that the specific information is browsed to the server when the determining unit determines that the specific information is browsed through the browsing unit, the server further includes: a browsing information storing unit that stores the browsing information transmitted from the client.

A browsing information gathering method according to a second aspect of the present invention is executed by a browsing information gathering system including a client and a server that stores data, the client and the server being connected together, the browsing information gathering method includes: a document requesting step that the client requests the data to the server; a data transmitting step that the server adds identification information to the data requested by the client and that transmits the data with the identification information to the client; a determining step that the client determines whether or not specific information is browsed based on the identification information added to the data; a browsing information transmitting step that the client transmits browsing information indicating that the specific information is browsed to the server when it is determined in the determining step that the specific information is browsed; and a browsing information storing step that the server stores the browsing information transmitted from the client.

A server according to a third aspect of the present invention includes: a data storing unit that stores data; a document data generating unit that generates document data browsable by the client based on the data when the data is requested on the client; a determining unit that determines whether or not the data requested by the client includes specific information; an adding unit that adds identification information indicating that the specific information is included and a script for determining whether or not the specific information is browsed by the client to the document data generated by the document data generating unit when the determining unit determines that the data includes the specific information; and a transmitting unit that transmits the document data to the client.

A computer-readable recording medium storing a program that allows a computer to function as: a document data generating unit that generates document data browsable by the client based on the data when the data is requested on the client; a determining unit that determines whether or not the data requested by the client includes specific information; an adding unit that adds identification information indicating that the specific information is included and a script for determining whether or not the specific information is browsed by the client to the document data generated by the document data generating unit when the determining unit determines that the data includes the specific information; and a transmitting unit that transmits the document data to the client.

### Effect of the Invention

According to the present invention, it becomes possible to preferably collect information browsed by a user.

### BRIEF DESCRIPTION OF DRAWINGS

FIG. 1 is a block diagram showing a configuration of a browsing information gathering system according to the present invention;

FIG. 2 is a block diagram showing a configuration of a client;

FIG. 3 is a block diagram showing a configuration of a WWW server;

FIG. 4 is a diagram showing an operation of the browsing information gathering system;

FIG. 5 is a diagram showing how to generate HTML texts;

FIG. 6 shows an illustrative browser screen displayed;

FIG. 7 is a flowchart, etc., showing an operation at the time of a screen change detecting process;

FIG. 8 shows an illustrative browsing information gathering script; and

FIG. 9 is a diagram showing a modified example of how to generate HTML texts.

### BEST MODE FOR CARRYING OUT THE INVENTION

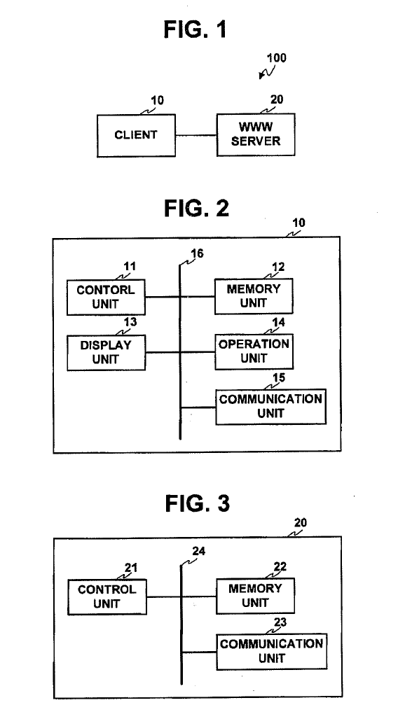

A browsing information gathering system 100 according to an embodiment of the present invention will be explained with reference to the accompanying drawings. FIG. 1 is a block diagram showing a configuration of the browsing information gathering system 100. As shown in FIG. 1, the browsing information gathering system 100 includes a client 10, and a WWW (World Wide Web) server 20. The client 10 and the WWW server 20 are connected together via a network, such as a LAN (Local Area Network) or a WAN (Wide Area Network).

FIG. 2 is a block diagram showing a configuration of the client 10. As shown in FIG. 2, the client 10 includes a control unit 11, a memory unit 12, a display unit 13, an operation unit 14, a communication unit 15, and a bus 16. The client 10 may further include a structural unit other than those units.

The control unit 11 is a microprocessor unit, etc., and controls the operation of the whole client 10. The control unit 11 runs an application program stored in the memory unit 12, thereby realizing necessary functions of the browsing information gathering system 100 of the present invention.

The memory unit 12 stores various pieces of data. The memory unit 12 includes a hard disk, a RAM (Random Access Memory) as a work area, and a ROM (Read Only Memory) storing an operation program, and the like. The memory unit 12 stores an application program of a browser which requests HTML (Hyper Text Markup Language) texts to the WWW server 20, and which browses the HTML texts. The memory unit 12 may be either one of a memory built in the client 10 or an external removable memory.

The display unit 13 is a liquid crystal display unit, etc., and displays various screens under the control of the control unit 11. The display unit 13 displays a browser screen under the control of the control unit 11. A user can browse HTML texts obtained from the WWW server 20 through the browser.

The operation unit 14 includes a keyboard, a mouse, and the like, and inputs an operation signal corresponding to an operation given to the keyboard, the mouse, etc., to the control unit 11. Upon a predetermined operation given to the operation unit 14 by the user, the browser is launched and the display unit 13 displays the browser screen. During the activation of the browser, scrolling of the browser screen and page jump are enabled by giving a predetermined operation to the operation unit 14.

The communication unit 15 is an interface for connecting the client 10 to the network. The client 10 transmits a request of obtaining HTML texts to the WWW server 20 through the communication unit 15, and receives the HTML texts from the WWW server 20. Moreover, the client 10 transmits browsing information to the WWW server 20 through the communication unit 15. The bus 16 exchanges data with individual units.

FIG. 3 is a block diagram showing a configuration of the WWW server 20. As shown in FIG. 3, the WWW server 20 includes a control unit 21, a memory unit 22, a communication unit 23, and a bus 24. The WWW server 20 may further include a structural unit other than those units.

The control unit 21 is a microprocessor unit, etc., and controls the operation of the whole WWW server 20. The control unit 21 runs an application program stored in the memory unit 22, thereby realizing necessary functions of the browsing information gathering system 100 of the present invention.

The memory unit 22 stores various pieces of data. The memory unit 22 includes a hard disk, a RAM as a work area, and a ROM storing an operation program, and the like. The memory unit 22 includes a database for accumulating and storing data like the personal information. The memory unit 22 stores an application program of generating HTML texts using the database in response to a request from the client 10, and transmitting the HTML texts to the client 10. The memory unit 22 includes an area for storing browsing information (a log) of HTML texts that is received from the client 10. The memory unit 22 may be either one of a memory built in the WWW server 20 or an external removable memory.

The communication unit 23 is an interface for connecting the WWW server 20 to the network. The WWW server 20 receives a request of obtaining HTML texts from the client 10 through the communication unit 15, and transmits the HTML texts to the client 10 therethrough. Moreover, the WWW server 20 receives browsing information (a log) from the client 20 through the communication unit 23. The bus 24 exchanges data with individual units.

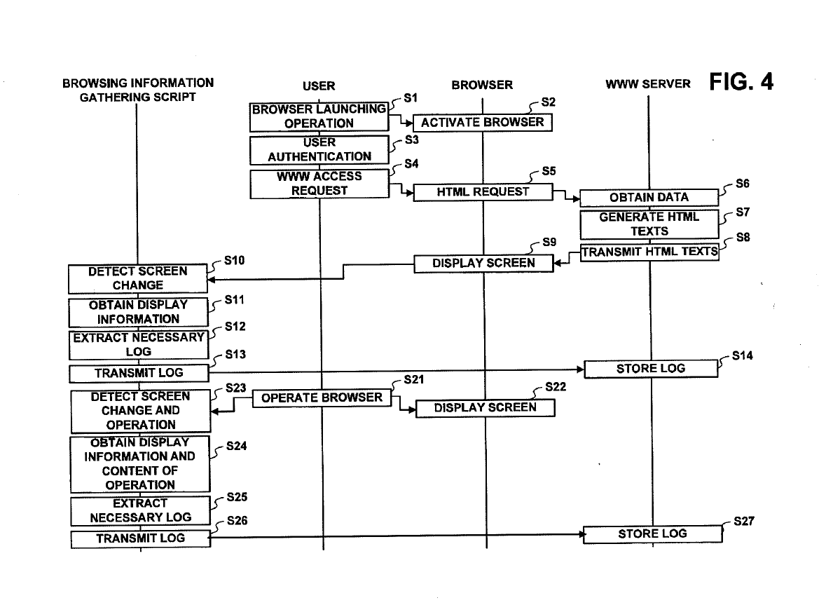

Next, an explanation will be given of an operation of the browsing information gathering system 100. FIG. 4 is a diagram showing an operation of the whole browsing information gathering system 100.

When the user browses HTML texts stored in the WWW server 20 from the client 10, first, the user gives a predetermined browser launching operation to the operation unit 14 of the client 10 (step S1), and the browser is launched (step S2). In the present embodiment, a user authentication is performed at the time of, for example, the launching of the browser (step S3).

When the user gives an operation to the operation unit 14 and requests a desired HTML texts (e.g., personal information) to the WWW server 20 (step S4), an HTML request of requesting the HTML texts is transmitted to the WWW server 20 from the client 10 through the browser (step S5).

When receiving the HTML request, the control unit 21 of the WWW server 20 obtains data corresponding to the requested HTML texts from the database in the memory unit 22 (step S6). Next, the control unit 21 generates HTML texts based on the obtained data (step S7), and transmits the generated HTML texts to the client 10 (step S8).

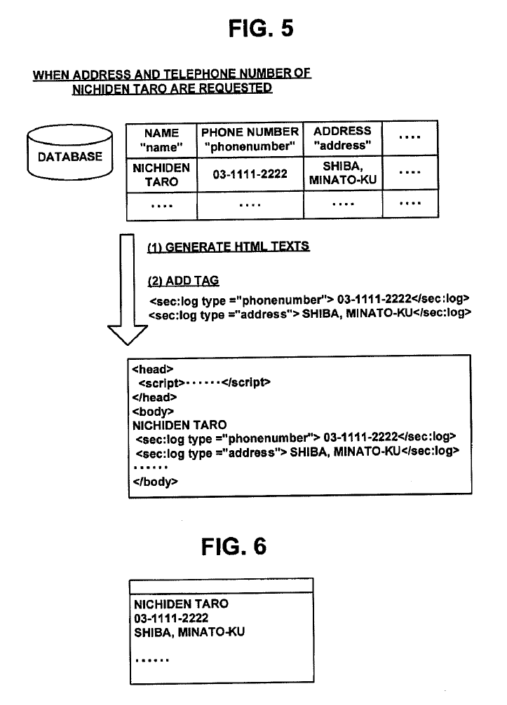

An explanation will be given of an operation when the control unit 21 of the WWW server 20 generates the HTML texts. The explanation will be given of an example case in which the address and telephone number of “NICHIDEN Taro” are requested. When the address and telephone number of “NICHIDEN Taro” are requested, as shown in FIG. 5, the control unit 21 extracts the address and telephone number of “NICHIDEN Taro” from the database stored in the memory unit 22, and generates HTML texts described in HTML. The HTML texts includes a script for collecting browsing information. Upon executing the browsing information gathering script, the control unit 11 monitors a screen displayed by the browser and an operation given by the user, thereby collecting information browsed by the user. Next, the control unit 11 transmits the collected information (a log) to the WWW server 20.

Next, tags <sec: log=“phonenumber”> and </sec: log> indicating that the item is the telephone number of the personal information are added to the telephone number in the HTML texts. Moreover, tags <sec: log=“address”> and </sec: log> indicating that the item is the address of the personal information are added to the address in the HTML texts.

In this way, the HTML texts added with tags shown in FIG. 5 is generated. The generated HTML texts are transmitted to the client 10.

The client 10 which has received the HTML texts causes the browser to display an HTML document corresponding to the HTML texts (step S9). When HTML texts shown in FIG. 5 are received, as shown in FIG. 6, a screen showing the address and telephone number of “NICHIDEN Taro” is displayed by the browser. When the browser displays the HTML document, the control unit 11 that has executed the browsing information gathering script detects that the screen of the browser is changed (the HTML document is displayed from a non-display state) (step S10), and information displayed by the browser is obtained (step S11).

Next, the control unit 11 determines whether or not confidential information like personal information is displayed by the browser and it is necessary to create a log, and if necessary, creates the log (step S12). The determination on whether or not the confidential information like the personal information is displayed by the browser is carried out based on, for example, whether or not a part added with a tag in the HTML texts is displayed. When creating the log, the control unit 11 transmits the created log to the WWW server 20 (step S13).

When receiving the log from the client 10, the WWW server 20 stores the received log in the memory unit 22 (step S14).

When the user gives an operation to the operation unit 14 while the browser is displaying the HTML document (step S21), the screen displayed by the browser is changed in accordance with the operation (step S22). The control unit 11 which has executed the browsing information gathering script detects that operation and the screen change of the browser (step S23). Next, the control unit 11 obtains the content of the operation given by the user and the information displayed by the browser (step S24).

The control unit 11 determines whether or not confidential information like personal information is displayed by the browser and it is necessary to create a log, and if necessary, creates a log (step S25). When creating the log, the control unit 11 transmits the created log to the WWW server 20 (step S26).

When receiving the log from the client 10, the WWW server 20 stores the received log in the memory unit 22 (step S27).

Next, an explanation will be given of an operation of the control unit 11 which has executed the browsing information gathering script. The control unit 11 determines that a screen is changed when detecting, for example, any one of the following operations as an example.

(1) When data reading to the browser completes.

(2) When the window size of the browser is changed.

(3) When the browser screen is scrolled.

(4) When the window of the browser is moved.

(5) When the status of the browser screen is changed (e.g., a start of data reading).

(6) When the property of the browser is changed (e.g., a change of color, an extraction of minimized page).

(7) When a mouse cursor is moved on the browser screen.

(8) When a mouse is operated.

When a screen change is detected, the control unit 11 executes a screen change detecting process for determining whether or not an area (a target element) displaying confidential information is included in the browser screen (a base element).

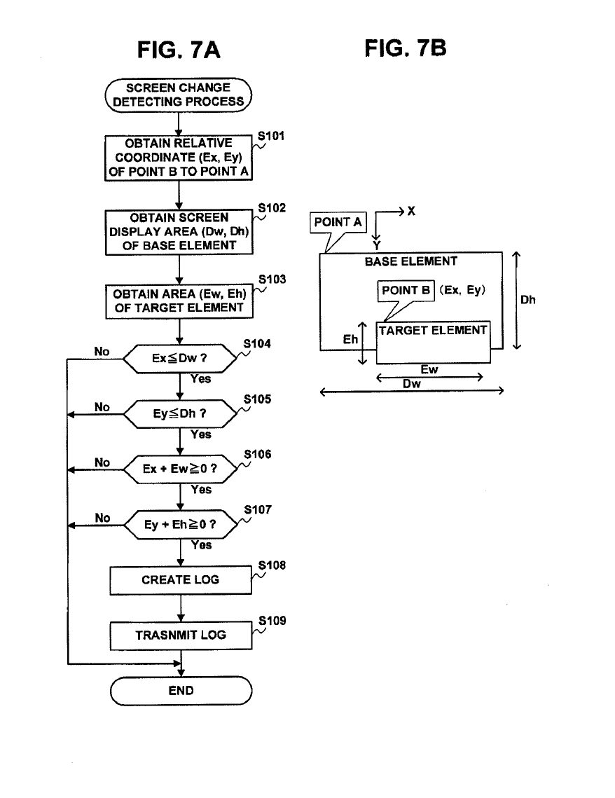

FIG. 7(A) is a flowchart showing an operation of the screen change detecting process. According to the screen change detecting process, first, the control unit 11 sets an end point of the base element (an upper left point) as a point A (see FIG. 7(B)), sets an end point of the target element (an upper left point) as a point B (see FIG. 7(B)), and obtains relative coordinates (Ex, Ey) of the point B to the point A (step S101). The control unit 11 reads HTML texts, and determines whether or not there is a character string added with a tag (<sec: log>) indicating that it is personal information. Next, when there is a character string added with the tag, the control unit sets the area of the character string as an area of the target element.

Next, the control unit 11 obtains the size (Dw, Dh) of the displayed area of the screen of the base element (step S102). Moreover, the control unit 11 also obtains the size (Ew, Eh) of the area of the target element (step S103).

Next, the control unit 11 determines whether or not the relative coordinate Ex of the point B is within the width Dw of the base element (step S104).

When the relative coordinate Ex of the point B is within the width Dw of the base element (step S104: YES), the control unit 11 determines whether or not the relative coordinate Ey of the point B is within the height Dh of the base element (step S105).

When the relative coordinate Ey of the point B is within the height Dh of the base element (step S105: YES), the control unit 11 determines whether or not a value obtained by adding the width Ew of the target element to the relative coordinate Ex of the point B is equal to or greater than 0 (step S106).

When the value obtained by adding the width Ew of the target element to the relative coordinate Ex of the point B is equal to or greater than 0 (step S106: YES), the control unit 11 determines whether or not a value obtained by adding the height Eh of the target element to the relative coordinate Ey of the point B is equal to or greater than 0 (step S107).

Through the processes from the step S104 to the step S107, it is determined whether or not an area (the target element) displaying confidential information is included in the browser screen (the base element).

When the value obtained by adding the height Eh of the target element to the relative coordinate Ey of the point B is equal to or greater than 0 (step S107: YES), it is determined that an area (the target element) displaying confidential information is included in the browser screen (the base element), and the control unit 11 creates a log of the displayed content (step S108), and transmits the log to the WWW server 20 (step S109).

When a determination result in any one of the steps S104 to S107 is NO, it is determined that no confidential information is displayed on the browser screen (the base element), and the process is terminated as it is.

The log created in the step S108 may be information added with a tag, user information specified through a user authentication, and information associated with date information. For example, information added with tags <sec: log=“phonenumber”> and </sec: log> is a telephone number, and information added with tags <sec: log=“address”> and </sec: log> is an address, so that it is appropriate if a log is created like “user information (name, login ID, etc.)-“telephone number: 03-1111-2222”-“address: Minato-ku, Shiba”-“Jun. 1, 2009”. The WWW server 20 accumulates such logs. When leaking of information occurs, if searching is executed with the leaked information being as a key, a user who has browsed the information and the date can be specified. Hence, the origin of the information leakage can be specified. Moreover, since accumulated logs are pieces of text information, it is possible to suppress a burden in volume originating from the increase of the logs.

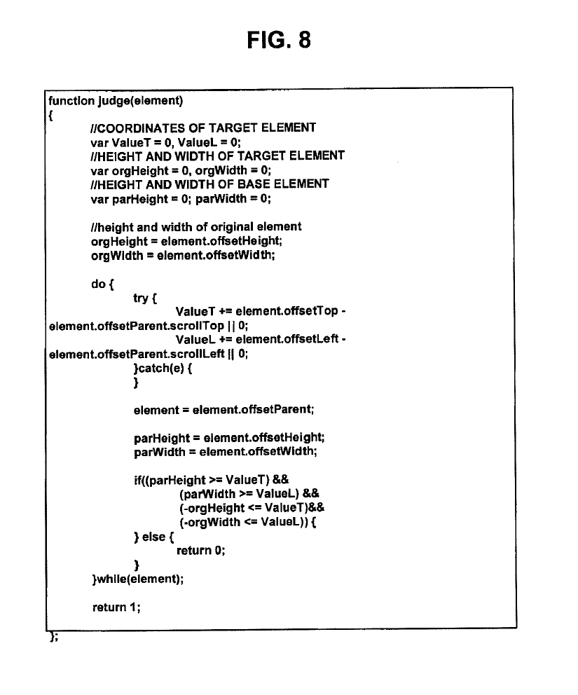

FIG. 8 shows an illustrative browsing information gathering script. It is appropriate if such a script is embedded when HTML texts are generated.

The above-explained embodiment is an example, and can be changed and modified in various forms without departing from the scope and spirit of the present invention. For example, in the screen change detecting process shown in FIG. 7A, the base element is the browser screen and the target element is an area displaying confidential information, but the target element may be a predetermined area including confidential information. In this case, when determination results in all of the steps S104 to S107 are YES, the processes from the step S101 to the step S107 are repeated with the target element being as a new base element. Determination on whether or not confidential information is displayed may be executed by narrowing down the target element in this fashion.

Moreover, the function of collecting information browsed by the user is realized by the control unit 11 that executes the browsing information gathering script in HTML texts, but may be implemented as a plug-in of the browser.

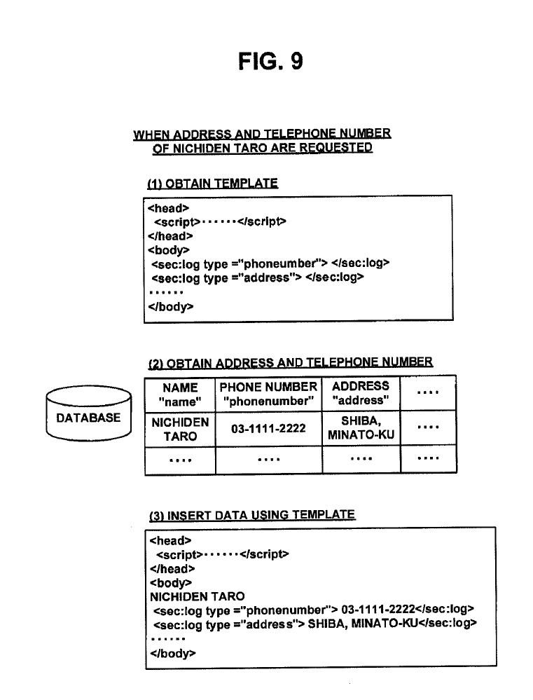

Furthermore, how to generate HTML texts by the WWW server 20 is not limited to the example shown in FIG. 5. For example, as shown in FIG. 9, a template of HTML texts corresponding to an obtaining request from the user may be prepared in advance, and data obtained from the database may be inserted in the template in order to generate HTML texts.

The WWW server 20 (1) stores the database that accumulates and stores data like personal information, (2) executes the process of generating HTML texts to be supplied to the user based on the data stored in the database, and (3) accumulates a log of browsing information, but those functions may be distributed into equal to or greater than two servers. For example, the WWW server 20 may be used as a server that stores a database which accumulates and stores data like personal information, and a management server may be separately provided which executes a process of generating HTML texts to be supplied to the user based on the data stored in that database, and which accumulates a log of browsing information. It is appropriate if those servers are connected to the client 10 through a network.

In the above-explained embodiment, the explanation was given of an example case in which confidential information is personal information, but the present invention can be applied to other kinds of confidential information like information for internal use only.

The explanation was given of the case in which the recording medium for realizing the present invention is stored in advance, but may be obtained from an external memory medium or may be transmitted over a network and stored.

This application is based on Japanese Patent Application No. 2009-129083 filed on May 28, 2009. The entire specification, claims, and drawings of Japanese Patent Application No. 2009-129083 are herein incorporated in this specification by reference.

### INDUSTRIAL APPLICABILITY

The present invention relates to a browsing information gathering system that collects information browsed by a user, and is applicable to an information processing device. Accordingly, the present invention has an industrial applicability.

### DESCRIPTION OF REFERENCE NUMERALS

10 Client
11 Control unit
12 Memory unit
13 Display unit
14 Operation unit
15 Communication unit
16 Bus
20 WWW server
21 Control unit
22 Memory unit
23 Communication unit
24 Bus
100 Browsing information gathering system

1. A browsing information gathering system including a client and a server that stores data, the client and the server being connected together,
the client comprising a document request unit that requests the data to the server,
the server comprising data transmitting unit that adds identification information to the data requested by the client and that transmits the data with the identification information to the client,
the client further comprising:
a browsing unit that browses the data transmitted from the server;
a determining unit that determines whether or not specific information is browsed through the browsing unit based on the identification information added to the data; and
a browsing information transmitting unit that transmits browsing information indicating that the specific information is browsed to the server when the determining unit determines that the specific information is browsed through the browsing unit,
the server further comprising:
a browsing information storing unit that stores the browsing information transmitted from the client.

2. The browsing information gathering system according to claim 1, wherein the determining unit determines whether or not the specific information is browsed through the browsing unit when data browsed through the browsing unit is changed.

3. The browsing information gathering system according to claim 1, wherein
the client further comprises:
an operation unit that executes an operation related to the data browsed through the browsing unit; and
an operation detecting unit that detects the operation to the operation unit, and
the determining unit determines whether or not the specific information is browsed through the browsing unit when the operation detecting unit detects the operation.

4. The browsing information gathering system according to claim 1, wherein
the browsing unit is capable of browsing data in a specific range in the data transmitted from the server, and
the determining unit determines whether or not the specific information is browsed upon determining whether or not the specific information is included in the specific range.

5. The browsing information gathering system according to claim 1, wherein
when the data requested from the client is the confidential information, the data transmitting unit adds the identification information to the data and transmits the data with the identification information to the client, the identification information specifying that the data is the confidential information, and
the determining unit determines whether or not the specific information is browsed based on whether or not the data added with the identification information specifying that the data is the confidential information is browsed through the browsing unit.

6. A browsing information gathering method executed by a browsing information gathering system including a client and a server that stores data, the client and the server being connected together, the browsing information gathering method comprising:
a document requesting step that the client requests the data to the server;
a data transmitting step that the server adds identification information to the data requested by the client and that transmits the data with the identification information to the client;
a determining step that the client determines whether or not specific information is browsed based on the identification information added to the data;
a browsing information transmitting step that the client transmits browsing information indicating that the specific information is browsed to the server when it is determined in the determining step that the specific information is browsed; and
a browsing information storing step that the server stores the browsing information transmitted from the client.

7. A server comprising:
a data storing unit that stores data;
a document data generating unit that generates document data browsable by the client based on the data when the data is requested on the client;
a determining unit that determines whether or not the data requested by the client includes specific information;
an adding unit that adds identification information indicating that the specific information is included and a script for determining whether or not the specific information is browsed by the client to the document data generated by the document data generating unit when the determining unit determines that the data includes the specific information; and
a transmitting unit that transmits the document data to the client.

8. (canceled)
